(19) United States
(12) Patent Application Publication
(10) Pub. No.: US 2002/0066160 A1
(43) Pub. Date: Jun. 6, 2002

(54) Auto-returning device of a hinge for a glass door

(76) Inventor: Fanny Chiang, Taichung (TW)

Correspondence Address: DELLETT AND WALTERS, 310 S.W. FOURTH AVENUE, SUITE 1101, PORTLAND, OR, 97204, US

(21) Appl. No.: 09/730,055

(22) Filed: Dec. 5, 2000

(51) Int. Cl. E05F 1/08

(52) U.S. Cl. 16/277

(57) ABSTRACT

An auto-returning device of a hinge for a glass door consists of a body, a spindle rotatably received in a vertically extending spindle hole defined in the body, at least two cylinder like push members respectively and movably received in two horizontal extending through holes defined in the body and in communication with the spindle hole, and at least two elastic members respectively received in opening ends of the push members, whereby close ends of the push members are forced by resilience of the elastic members to press against a flat of the spindle, when a hinge assembled with the auto-returning devices is secured on a glass door and hangs the glass door on a door frame. Each push member of the auto-returning device is able to slide smoothly in the corresponding through hole of the body of the auto-returning device, so that the auto-returning device performs reliably and durably.

### BACKGROUND OF THE INVENTION

1. Field of the Invention

The present invention relates to an auto-returning device of a hinge used for a glass door, particularly to an auto-returning device, which is extremely reliable and durable.

2. Description of Related Art

There are two types of commonly-used hinge for glass doors. A first type of hinge is mounted on the wall and secured at one side of a glass door. A second type of hinge is mounted on upper or lower doorframes and secured at upper and lower ends of the glass door.

As shown in FIG. 7, the first type of hinge comprises a base plate (40) mounted on a wall (50), two fixing plates (41) respectively secured at opposite surfaces of one edge of a glass door (42), and an auto-returning device (60). The auto-returning device (60) is securely fixed with the base plate (40) at a first edge thereof and pivotally connected with the fixing plates at a second edge thereof.

With reference to FIGS. 8 to 10, the auto-returning device (60) consists of a body (61), a spindle hole (62) defined vertically in the body (61), two through holes (63) defined horizontally in the body (61) and in communication with the spindle hole (62), a spindle (64) rotatably received in the spindle hole (62), two T-shaped members (66) respectively and movably received in the through holes (63), and two springs (69) respectively received in the through holes (63) between the T-shaped members (66) and the fixed plate (40). The spindle (64) is formed with a round surface, and a flat (65) corresponding to the through holes (63). Each one of the T-shaped members (66) has a large end (67) pressed against the flat (65) of the spindle (64), and a small end (68) inserted into the corresponding spring (69). When the glass door (42) is opened, the spindle (64) turns along with the fixing plates (41) and the glass door (42), and the large end (67) of each T-shaped member (66), pressed by the round surface of the spindle (64), moves towards the corresponding spring (69). The spring (69) is compressed by the T-shaped member (66). When the glass door (42) is closed, the T-shaped member (66) is forced by the resilience of the springs (69) to move towards the spindle (64) till the flat (65) of the spindle (64) abuts the large end (67) of each T-shaped member (66) in a face to face way. 0 With reference to FIG. 11, a second type of hinge comprises a base plate (40) mounted on a doorframe (51), two fixing plates (41) secured at opposite surfaces of an upper end of a glass door (42), and an auto-returning device. The auto-returning device has a spindle (70) formed with two flats (71) at opposite sides thereof An upper end of the spindle (70) is securely connected with the base plate (40). A lower end of the spindle (70) is extended through a spindle hole vertically defined in a center of a body (72). Each side of the body (72) has two through holes (73) horizontally defined therein and in communication with the spindle hole. Each through hole (73) has an inner thread (74) formed at an opening end thereof, a T-shaped member (75) movably received in the through hole (73) and contacted against one of the flats (71) of the spindle (70), and a spring (76) received between the T-shaped member (75) and a bolt (77) threadingly engaged with the inner thread (74) at the opening end of the through hole (73).

The above mentioned conventional auto-returning devices of hinges for glass doors have following defects:

1. Because the T-shaped member contacts with the inner surface of the through hole by only an outer surface of its large end, it is positioned in the through holes in an unstable way, the T-shaped member axially move in the through holes along with radially swing;

2. The T-shaped member may be jammed in the through hole when it is moving along the through hole during the opening or closing of the glass door;

3. As the T-shaped member is often excessively abraded during the normal operations, the useful life of the auto-returning device of the hinge does not reach the optimum.

Therefore, it is an objective of the invention to provide an improved auto-returning device for a hinge of glass door to mitigate and/or obviate the aforementioned problems.

### SUMMARY OF THE INVENTION

The object of the present invention is to provide an auto-returning device of a hinge for a glass door, the auto-returning device consisting of a body, a spindle rotatably received in a vertically extending spindle hole defined in the body, at least two cylinder like push members respectively and movably received in two horizontally extending through holes defined in the body and in communication with the spindle hole, and at least two elastic members respectively received in opening ends of the push members, whereby closed ends of the push members are forced by resilience of the elastic members to press against a flat of the spindle, when a hinge assembled with the auto-returning devices is secured on a glass door and hangs the glass door on a door frame. The push members of the auto-returning device are able to slide smoothly in the corresponding through hole of the body of the auto-returning device, so that the auto-returning device performs reliably and durably.

The detailed features of the present invention will be apparent in the detailed description with appropriate reference to the accompanying drawings.

### BRIEF DESCRIPTION OF THE DRAWINGS

FIG. 1 is an exploded perspective view of an auto-returning device of a hinge in accordance with the present invention;

FIG. 2 is a perspective view of a first embodiment of the hinge in accordance with the present invention;

FIG. 3 is a cross sectional plan view of the first embodiment of the auto-returning device of the hinge in accordance with the present invention;

FIG. 4 is an operating schematic view of the first embodiment of the auto-returning device of the hinge in accordance with the present invention;

FIG. 5 is a cross sectional elevation view of the first embodiment of the auto-returning device of the hinge in accordance with the present invention;

FIG. 6 is a cross sectional elevation view of a second embodiment of the auto-returning device of the hinge in accordance with the present invention;

FIG. 7 is a schematic view of a glass door hung by conventional hinges;

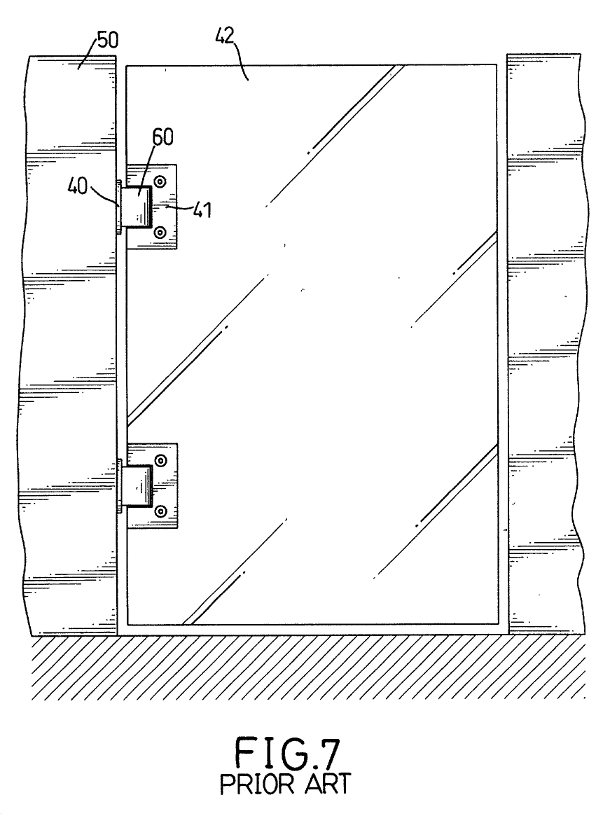

FIG. 8 is an exploded perspective view of a first type of an auto-returning device of the conventional hinge;

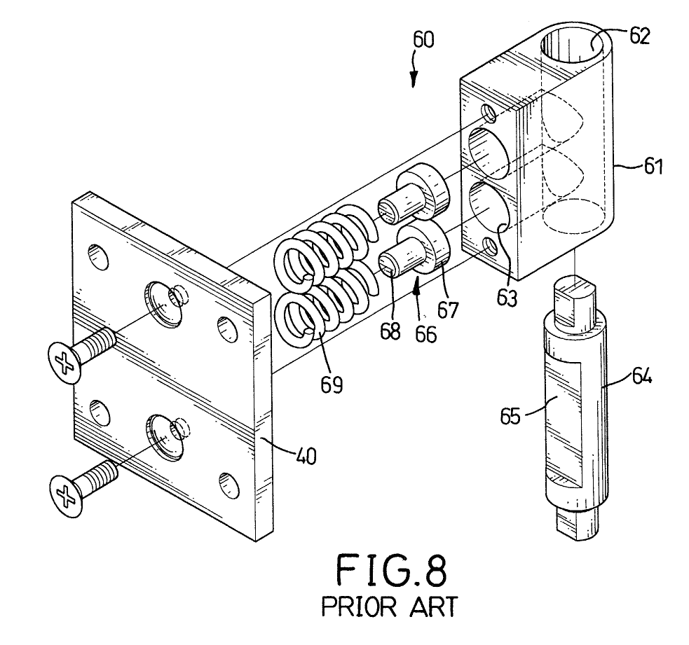

FIG. 9 is a cross sectional plan view of the first type of the auto-returning device;

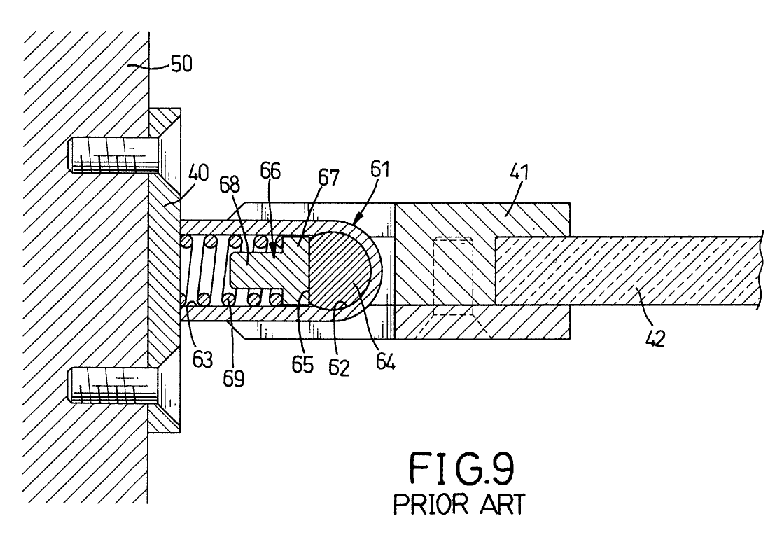

FIG. 10 is an operating schematic view of the first type of the auto-returning device of the conventional hinge; and

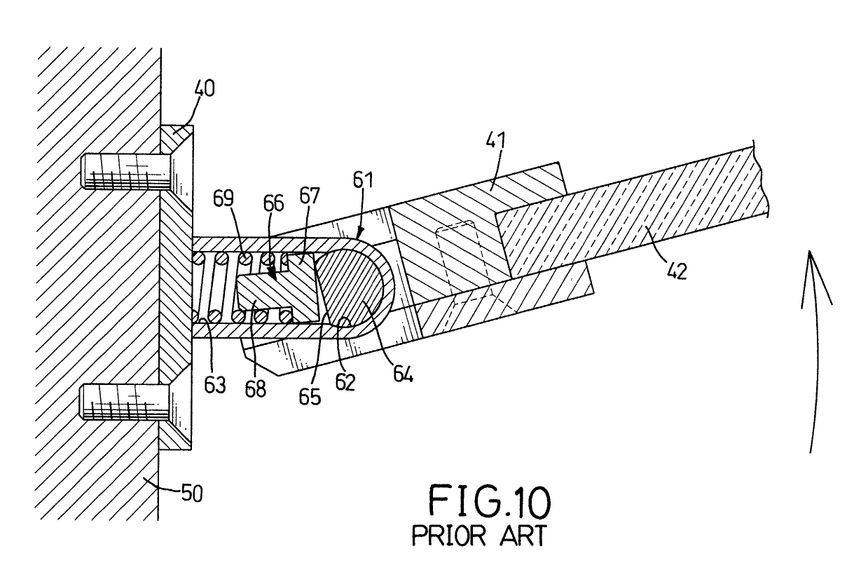

FIG. 11 is cross sectional elevation view of a second type of an auto-returning device of the conventional hinge.

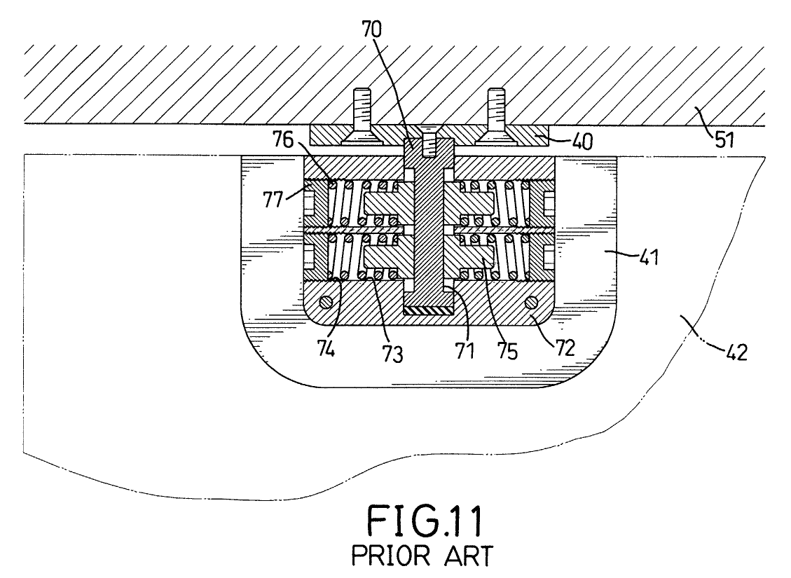

### DETAILED DESCRIPTION OF THE PREFERRED EMBODIMENT

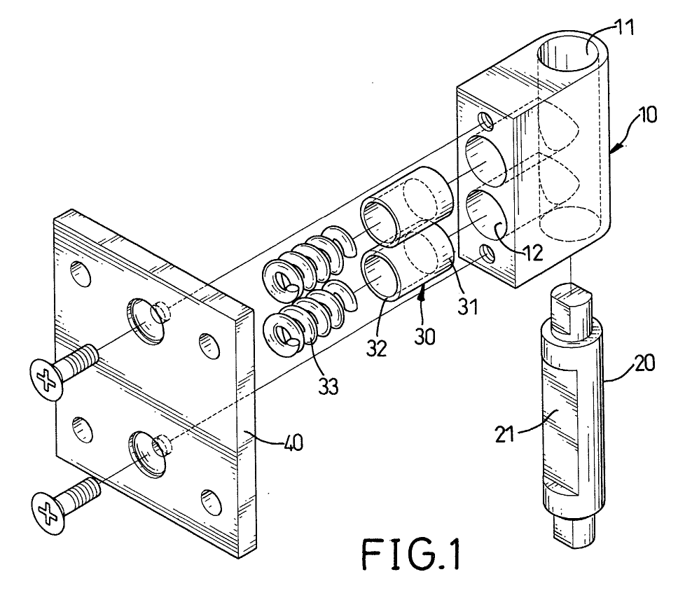

As shown in FIG. 1, a first embodiment of an auto-returning device of a hinge in accordance with the present invention comprises a body (10), a spindle (20), two cylinder like push members (30) and two elastic members (33).

The body (10) has a vertically extending spindle hole (11) defined therein near a first side thereof. Two through holes (12) extending horizontally are respectively defined in a second side of the body (10) and in communication with the spindle hole (11).

The spindle (20) is rotatably received in the spindle hole (20) and formed with a certain length of flat (21) corresponding to a distance between outermost edges of the two though holes.

The push members (30) are respectively and movably received in the through holes (12). In particular, each one of the push members (30) is formed as a cylinder member having a closed end (31) abutting the flat (21) of the spindle (20) and an opening end (32) with the elastic member (33) received therein.

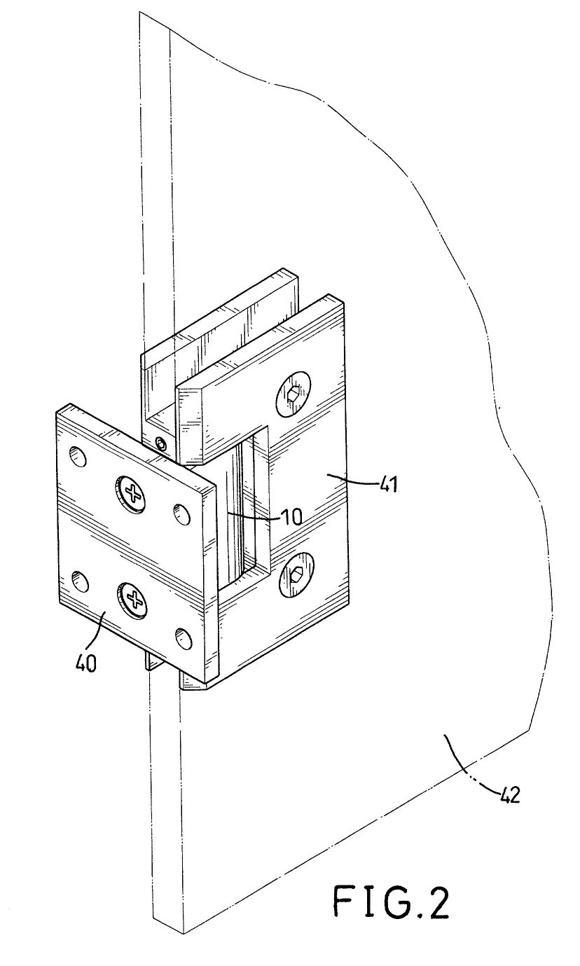

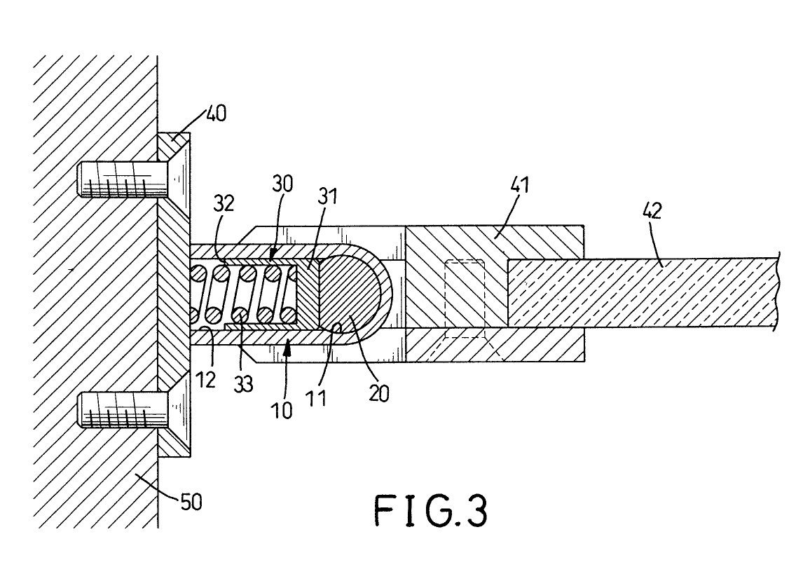

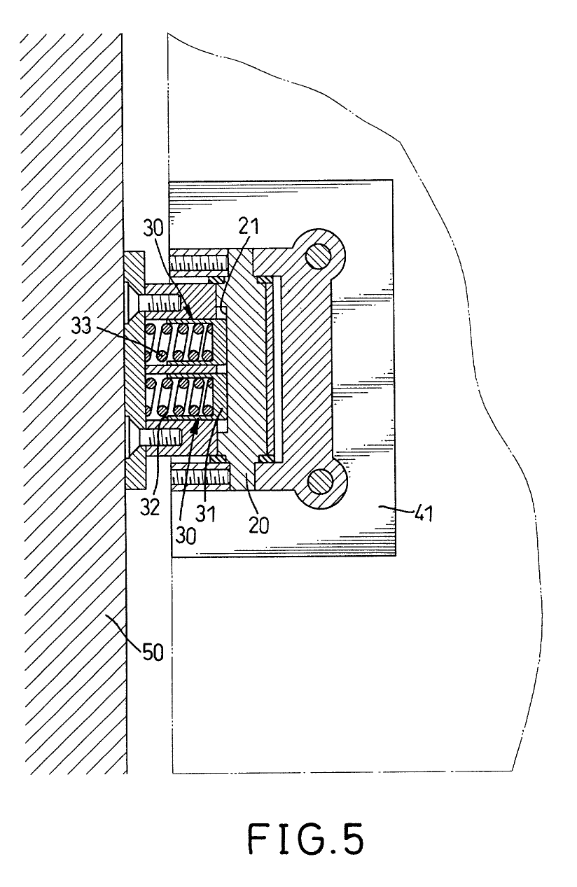

Now with reference to FIGS. 2, 3 and 5, the second side of the body (12) is securely fixed with a base plate (40) which is fixedly mounted on a wall (50), whereby each elastic member (33) is limited between the base plate (40) and the closed end of the corresponding push member (30).

Two opposite ends of the spindle (20) are respectively connected with two fixing plates (41). A glass door (42) is securely sandwiched in the two fixing plates (41).

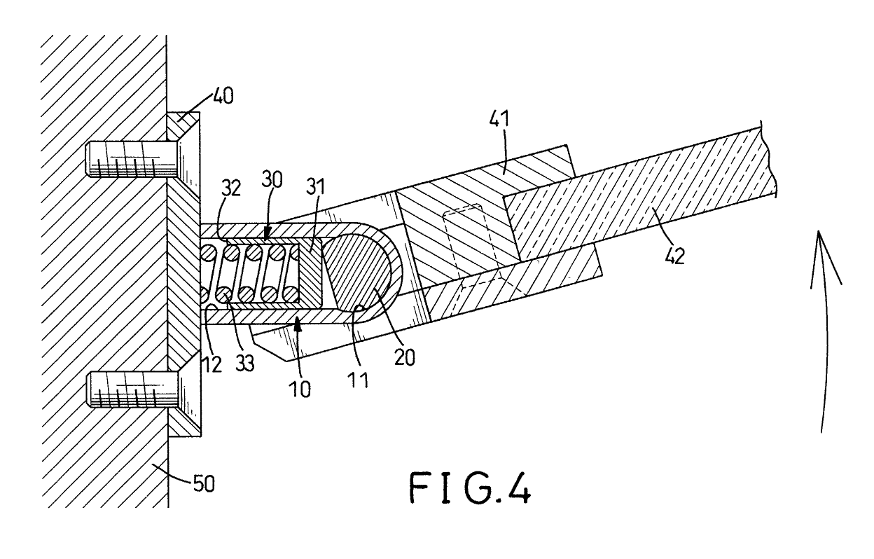

When the glass door (42) is at a fully closed position, the closed end (31) of each push member (30) forced by the resilience of the corresponding elastic member (33) is abutted against the flat (21) of the spindle (20). When the glass door (42) is opened as shown in FIG. 4, the spindle (20) turns around its own axis, each push member (30) pressed by the round surface of the spindle (20) moves towards the corresponding elastic member (33), and each elastic member (33) is compressed by the corresponding push member (30). Afterwards, when the glass door (42) is pulled back to its closed position, the push members (30), forced by resilience of the elastic members (33), move towards the spindle (20) again. Because the flat (21) of the spindle (20) is pressed by the closed end (31) of each push member (30), the spindle (20) turns back till the glass door (42) is returned to its fully closed position. Furthermore, the flat (21) also abuts the closed end (31) of each push member (30) again.

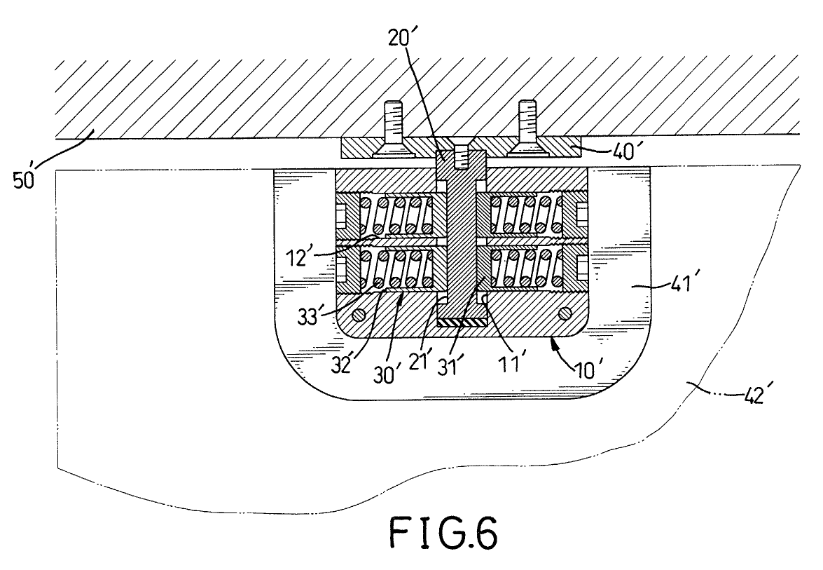

FIG. 6 shows a second embodiment of the auto-returning device of the hinge in accordance with the present invention. A base plate (40′) is mounted on a bottom surface of a doorframe (50′). A spindle (20′) is securely connected with the base plate (40′) at an upper end thereof. A lower end of the spindle (20′) is rotatably received in a vertically extending spindle hole (11′) defined in a center of a body (10′) of the hinge. At least two horizontally extending through holes (12′) are respectively defined in each side of the body (10′) and in communication with the spindle hole (11′). The spindle (20′) is formed with two flats (21′) at opposite sides thereof. Each flat (21′) has a certain length corresponding to distance between outermost edges of each two though holes defined at a corresponding side of the body (10′). Each through holes (12′) has a cylinder like push member (30′) movably received therein. Each push member (30′) has a closed end (31′) abutting the corresponding flat (21′) of the spindle (20′) and an opening (32′) with an elastic member (33) received therein. Opening ends of the through holes (12′) are respectively and threadingly engaged with a bolt, whereby the elastic members (33′) are respectively limited between the bolt and the corresponding closed end (31 ′) of the push member (30′). Two fixing plate (41′) are respectively secured with the body (10′). A glass door (42′) is securely sandwiched in the two fixing plate (41′). The operation principle of the second embodiment of the auto-returning device of the hinge of the glass door is same as the first embodiment.

Because the cylinder like push members (30, 30′) have a large surface area contacted with the inner surface of the corresponding through holes (12, 12′), the push member (30, 30′) slides smoothly along the through hole (12, 12′). The elastic member (33, 33′) received in the opening end (32, 32′) of each push member (30, 30′) is compressed in a stable way by limitation of the inner cylinder surface of the push member (30, 30′). In such a way, the auto-returning device of the invention obtains a good working reliability and a prolonged useful life.

The auto-returning device of the invention has following advantages:

1. As the cylinder like push members (30, 30′) have a large surface area abutting the inner surface of the corresponding through holes (12, 12′), the push members (30, 30′) is positioned stably, so that the auto-returning device works reliably;

2. Because the cylinder like push members (30, 30′) move along the though holes (12, 12′) smoothly and stably, contacting surfaces of the push members (30, 30′) and the through holes (12, 12′) are less abraded; and

3. The useful life of the auto-returning device of the invention is prolonged.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An auto-returning device of a hinge for a glass door comprising
a body having a spindle hole defined therein, and at least two through holes respectively defined therein and in communication with the spindle hole;
a spindle rotatably received in the spindle hole and having a flat portion with a length corresponding to a distance between outermost edges of the though holes;
at least two cylinder like push members respectively and movably received in one of the through holes, each one of the push members having a closed end abutting the flat portion of the spindle and an open end with an elastic member received therein.

2. The auto-returning device of a hinge for a glass door as claimed in claim 1, wherein the elastic member is a spring.
